(19) United States
(12) Patent Application Publication
(10) Pub. No.: US 2004/0119423 A1
(43) Pub. Date: Jun. 24, 2004

(54) Hi lumen dimmed lamp method and system

(75) Inventor: Timothy Yablonowski, Naples, CA (US)

Correspondence Address: Brinks Hofer Gilson & Lione, NBC Tower, Suite 3600, P.O. Box 10395, Chicago, IL, 60610, US

(73) Assignee: Ultrawatt Energy Systems, Inc.

(21) Appl. No.: 10/323,125

(22) Filed: Dec. 18, 2002

(51) Int. Cl. H05B 37/02

(52) U.S. Cl. 315/291; 315/224; 315/246; 315/312

(57) ABSTRACT

A standard ballasted lamp is altered to increase the lumen output while operating at a same wattage. The lamp is used with a dimmer or other energy consumption reduction device. The increased lamp output of light is off-set by the reduced energy consumption. While the life of the lamp may be shorted for normal use, use with reduced energy consumption provides for a similar or increased light output from lamps as compared to standard lamps, but at a reduced energy consumption.

### BACKGROUND

This invention relates to ballasted lamps. For example, T8 fluorescent lamps are in common use in office buildings and residences. Ballasts control one or more T8 fluorescent lamps. A typical T8 fluorescent lamp provides about 2,950 initial lumens operating at 32 watt power levels. The life of such lamps may be around 20,000 based on life average rated hours. Various economic factors result in these common characteristics of standard T8 lamps.

The ballasts may be dimmed to reduce the light output. The light output may also be reduced by using fewer lamps, such as removing one of two, three or four lamps operated by a particular ballast. The light output may be reduced by systems adapted to conserve power or reduce energy costs, such as the power savings system disclosed in U.S. Pat. Nos. 5,583,423; 5,754,036 and 6,172,489 operated in a power savings mode.

To increase light output, the wattage of the ballast and lamps is increased. Replacement of ballasts to increase wattage is expensive. Instead of replacement, additional lamps and/or ballasts may be added at further expense.

### BRIEF SUMMARY

The present invention is defined by the following claims, and nothing in this section should be taken as a limitation on those claims. By way of introduction, the embodiments described below include methods and systems for consuming less power while providing sufficient light output. A standard ballasted lamp is altered to increase the lumen output while operating at a same wattage. The lamp is used with a dimmer or other energy consumption reduction device, resulting in similar but possibly still increased light output as compared to a standard lamp at full power operation. The increased output of light is off-set by the reduced energy consumption. The life of the altered lamp may be shorted, but the use with reduced power may allow for increased life. The cost of any shortened life may be off-set by the reduced power consumption without sacrificing the light output.

In a first aspect, a method for using hi lumen, ballasted lamps is provided. A ballasted lamp with an increased initial lumen output and substantially same wattage rating is provided. A power provided to the ballasted lamp is reduced during operation.

In a second aspect, a system for using hi lumen, ballasted lamps is provided. A ballasted lamp has an increased initial lumen output and substantially same wattage rating. A power reduction device electrically connects with the ballasted lamp.

In a third aspect, a method for using hi lumen, ballasted lamps is provided. Energy consumption by a ballasted lighting system is reduced with a energy reduction device separate from lamps of the ballasted lighting system. A lighting level output decrease due to the reduction is at least partially off-set with at least one lamp of the lamps having an increased initial lumen rating.

Further aspects and advantages of the invention are discussed below in conjunction with the preferred embodiments.

### BRIEF DESCRIPTION OF SEVERAL VIEWS OF THE DRAWINGS

FIG. 1 is a block diagram of one embodiment of a system for using hi lumen ballasted lamps.

FIG. 2 is a graphic representation of a fluorescent lamp in one embodiment.

FIG. 3 is a flow chart diagram of one embodiment of a method for using hi lumen ballasted lamps.

### DETAILED DESCRIPTION OF THE PREFERRED EMBODIMENTS

Lighting output reduction due to dimming or energy conservation is off-set by using an increased lumen lamp. The wattage is maintained or is similar to standard lamps of the same type.

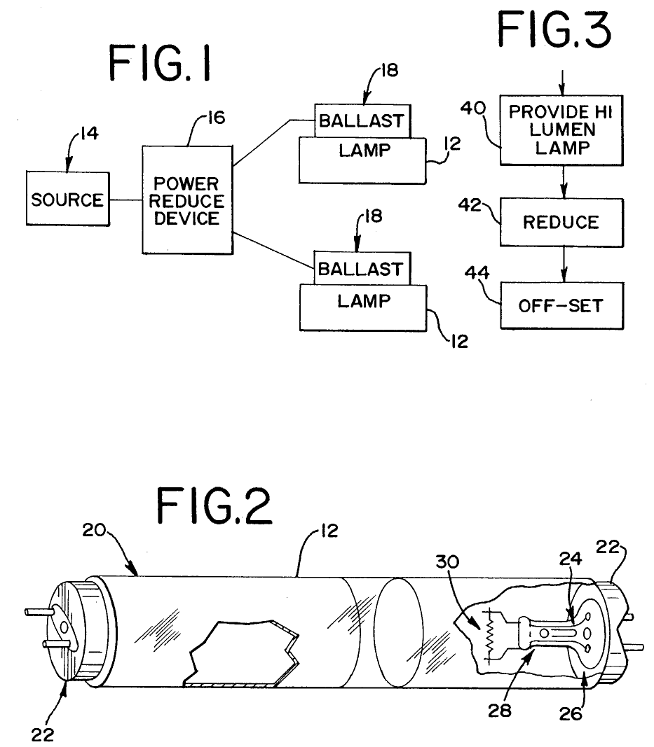

FIG. 1 shows a system 10 for using hi lumen, ballasted lamps. The system 10 includes one or more ballasted lamps 12, an alternating current (AC) source 14, a power reduction device 16 and one or more ballasts 18. Additional, fewer or different components may be used. For example, additional power reduction devices 16 connect with a single or multiple ballasts 18. As another example, the system 10 includes only a single ballast 18 and/or ballasted lamp 12. In some embodiments, each ballasted lamp 12 comprises a different device, such as different types of lighting loads. For example, HID and fluorescent lighting loads are provided as separate lamps 12 on a same circuit.

The AC source 14 comprises a source of line voltage, such as provided by a utility, an alternating current generator, a transformer, a breaker box or circuit panel, a DC to AC converter, or another source. The AC source 14 provides a line voltage and current for operation of the lighting system 10.

The ballasted lamps 12 comprise fluorescent, high intensity discharge (HID) or other light sources controlled by a ballast. For example, the ballasted lamps 12 comprise T8 fluorescent lamps, but T5, T10, T12, curved, straight or any other sized and shaped fluorescent lamp now know or later developed may be used. As another example, base-up, pulse start, universal, horizontal or other HID lamps are used. The HID lamps are coated or clear metal halide, high pressure sodium or other HID lamps now known or later developed.

FIG. 3 shows a fluorescent lamp 12. The lamp 12 includes a bulb 20, such as a circular, straight or U-shaped glass cylinder. One or more bases 22 connect with the bulb 20 and are adapted for electronic connection with the ballast 18 and physical connection with a lamp holder, such as by having two conductive prongs. A stem press 28 with an exhaust tube 24 and lead-in wires 26 holds a cathode 30. The cathodes 30 at each end of the lamp 12 comprise coiled-coil or single coil tungsten wire, but other materials and coils now known or later developed may be used. The cathodes 30 are coated with an emissive material, but uncoated cathodes 30 may be used. The bulb 20 is coated with a phosphor or other material for converting non-visible (e.g. ultraviolet) radiation into visible light. Different compositions of phosphor or other material may be used. The bulb 20 is filled with one or more inert gases in a vacuum of less than one atmosphere. For example, krypton, argon, neon or a mixture of gases are provided at 2 to 3 torr of pressure. A small amount of mercury liquid or gas is also provided in the bulb 20. The mercury allows for a low pressure mercury vapor arc to generate ultraviolet, visible or other radiation.

The ballasted lamps 12 are altered from a standard lamp. The ballasted lamps 12 have an increased initial lumen output, but substantially same wattage rating as a standard lamp. For example, a standard T8 lamp has a 2,950 or about 3,000 initial lumen rating for operation at about 32 watts (e.g. 31 or 32 watts). The ballasted lamps 12 are altered to have at least a 4,000 initial lumens rating for operation at a substantially similar wattage. Substantially allows for manufacturing tolerances and/or lamp designs within 10% of the wattage rating. In one embodiment, the ballasted lamps 12 have twice the initial lumen rating of the standard lamps of the same type (e.g. T8 with 5,900 initial lumens) for operation at a similar wattage. In another example embodiment, a 400 watt metal halide high intensity discharge lamp is altered to have increased lumen output (e.g. from a standard 41,000 or 50,000 initial lumens to 82,000 or 100,000 initial lumens, respectively). As used herein, alteration includes changes to existing components, changes to design prior to manufacture or replacing a lamp in a ballast with a lamp of different characteristics.

The ballasted lamps 12 are altered from standard lamps by changes of one or more characteristics to provide for increased lumens at a same wattage. For a fluorescent lamp example, one or both cathodes are enlarged, such as using a thicker wire, longer wire, plate or combinations thereof. Different cathode materials or a reduction in size may be used to increase the lumens with a similar wattage. As another example, an amount or concentration of one or more gases is changed. A change in the concentration of mercury, the vacuum or pressure in the bulb 20 or other characteristic of the lamp 12 may also provide increased lumens at a similar wattage. HID lamps are altered in similar ways, such as by increasing the size of an element, using different element material, changing a pressure, and/or changing vapor composition. Any combination of two or more changes may be also be used.

Other characteristics of the ballasted lamps 12 change or remain the same after increasing the initial lumen rating. For example, the life average rated hours of the T8 fluorescent lamp described above may be reduced from about 20,000 to less than 15,000 (e.g. about 10,000) with the change in initial lumens. As another example, the life average rated hours of the 400 watt HID described above may be reduced from about 20,000 to less than 15,000 (e.g. about 10,000). Changes other than the 25-50% reduction in life for about a 50% change in lumens may result. Different color temperature and color rendition index (CRI) ratings may also result for either HID or fluorescent lamps, but are substantially the same in one embodiment (e.g. 32 watt T8 fluorescent lamps with 3000 K and 82 CRI or 400 watt metal halide HID lamps with 40,000K and 70 CRI regardless of the initial lumens).

The ballasts 18 comprise any device for starting and operating the lamps 12. For example, electronic, magnetic, rapid start, instant start, low voltage or line voltage control dimming, combinations thereof or other now known or later developed ballasts operate fluorescent lamps. As another example, constant wattage auto transformers, reactor type or other now known or later developed ballasts operate HID lamps. The ballasts 18 operate lamps 12 of a particular wattage, such as a ballast 18 adapted to operate 32 watt fluorescent lamps, but ballasts 18 operable to power lamps of different wattages may be used.

The power reduction device 16 comprises a dimmer, energy conservation device or other now known or later developed device for reducing power to a lighting load. For example, an autotransformer or dimming ballast reduces power by altering the peak voltage provided to the lamps 12. In other embodiments, a Thyristor switch system is used. The power reduction device 16 is separate or spaced from the lamp 12, but electrically connects with the ballasted lamp 12. In one embodiment, the power reduction device 16 is positioned near a circuit breaker or lighting circuit header. In another embodiment, the power reduction device 16 is integrated with the ballasts 18. For example, a dimming ballast 18 is used. Power reduction may result in less light output, such as partially or fully off-setting the increased initial lumens of the ballasted lamps 12. For example, the power to the T8 fluorescent lamp with an increased 5,900 initial lumens is reduced so that about 3,000 or more lumens are output initially. Other numbers may be provided for initial or aged operation.

In one embodiment, the power reduction device 16 provides to the ballasted lamp 12 less RMS voltage with a substantially same peak as a line voltage. The power reduction device 16 comprises a power savings unit or voltage reduction system. Examples of such power reduction devices are disclosed in U.S. Pat. Nos. 5,583,423; 5,754,036 and 6,172,489, assigned to the assignee of the present invention, the disclosures of which are incorporated herein by reference. For example, an AC power switch or switches connect in parallel with a capacitor. The power switch and capacitor are connected in series in between the AC source 14 and the lamps 12. Control circuitry operates the switch to reduce the root mean square voltage or power provided to the lamps 12. To reduce the root means square voltage or current, the switch is turned on at each zero crossing and turned off prior to a zero crossing of a half cycle of the AC cycle waveform, passing current through the parallel capacitor. Other switch turn-on and off timings may be used.

The amount of power reduction is selected as a function of a desired lighting output. Other variables, such as a desired power savings, hours of operation, utility arranged curtailment, lighting depreciation compensation, by-pass mode operation and calibration, may also be used to determine an amount of power reduction. In one embodiment, a power savings mode provides 20-50% reduction in power provided to the lamps 12 for saving utility costs or power usage. For example, a user selectable amount of power reduction (e.g. 40%) provides sufficient light while minimizing use of the current or power. Since the initial lumen rating of the lamps 12 is increased, the power reduction is provided with minimal or no loss of light. In one embodiment, the power reduction is provided with an. increase in light output.

In one embodiment, the system 10 includes additional hardware and capabilities. A revenue accurate meter is provided for monitoring the power drawn from the utility. Communication power supplies and modules interconnect the various components of the system 10. An uninterrupted power supply for operation of the system 10 during an interruption in power from the AC source 14 is provided. Various wiring harnesses and jumpers for interconnecting the components are also provided. For an example of a lighting control unit network, see U.S. Pat. Nos. ______, and ______, (U.S. application Ser, No. 09/454,775, filed Dec. 3, 1999 and Ser. No. 09/541,264, filed Apr. 3, 2000), assigned to the assignee of the present invention, the disclosures of which are incorporated herein by reference. Various communications between components of the system 10 control of the system 10.

FIG. 2 shows a flowchart of a method for using hi lumen ballasted lamps 12. A ballasted lamp with hi lumen output is provided in act 40. In act 42, power provided to a lamp 12 is reduced. The increased lumens are at least partially offset by the reduction in power. The lighting level is substantially similar to or greater than a standard ballasted lamp of a same type at full power due to the increased initial lumen rating, but with less power consumption. Additional, fewer or different acts may be provided.

In act 40, a ballasted lamp with an increased initial lumen output as compared to a standard lamp of the substantially same wattage is provided. For example, a T8 fluorescent lamp with an increased cathode size is operable at 32 watts to provide at least 4,000, 5,000, 6,000 or other initial lumens as compared to the standard about 3,000 initial lumens. The T8 fluorescent lamp may have decreased life average rated hours, such as less than 15,000, 10,000 or other value as compared with the standard about 20,000. As another example, a metal halide HID lamp with an increased element size is operable at 400 watts to provide at least 60,000 initial lumens as compared to the standard about 40,000 or 50,000 initial lumens. The metal halide HID lamp may have decreased life average rated hours, such as less than 15,000 as compared with the standard about 20,000.

In one embodiment, the lamps 12 with increased lumens but a lesser life for operation at a same wattage are sold specifically for operation with a power reduction device, since the power reduction may off-set the costs of lesser life and may extend the life of the lamp. In other embodiments, lamps 12 with the increased lumens for a same wattage are sold without reference to specific operation with a power reduction device 16. Developments may alter the standard for initial lumens, but in general lighting systems are designed based on prevailing lighting output capabilities with a market determined life. More drastic changes, such as 25%, 50%, 75%, 100% or other percentages in initial lumens at a same wattage but with less life, may over light an area without dimming. The standard lamp used may be design or system specific, such as designing a system 10 for use with T8 32 watt lamps with 50,000 initial lumens as opposed to 41,000 initial lumens. By increasing the initial lumens above the designed lighting output, such as by 50%, lamps 12 with an increased initial lumen output as compared to the standard are provided. By increasing the initial lumens above industry wide standard lamps, lamps 12 with an increased initial lumen output as compared to the standard are provided.

In act 42, the power provided to the ballasted lamp 12 during operation is reduced as compared to the line current and voltage provided by the AC source 14 or ballast 18 without reduction. For example, the peak-to-peak voltage provided to the lamp 12 is reduced by a dimmer. In one embodiment, a T8 lamp with an increased initial lumen rating of about 5,900 is dimmed by reducing the peak voltage such that about 3,000 initial lumens are output. Where the lamps 12 have a warm-up period, full power or sufficient power for a warm-up period is provided before any or further reduction in the power. For other lamps 12, the reduction is immediate or delayed in response to user control, in response to processor control or other control.

As another example, the RMS voltage is reduced without substantial reduction in peak voltage such that an output of the lamps 12 is reduced. In one fluorescent T8 32 watt embodiment, the RMS voltage is reduced so that the lighting output is less than an initial lumens rating (adjusted for any life of the lamp) but greater than the initial output of a standard lamp (e.g. greater than 3,000 lumens) at full power. A lesser or same lighting output may be used. Using a power conservation device, the amount of power is reduced in a power savings mode of operation. One of different levels of power savings are provided. For example, 40%, 30%, 20% or other amount of power savings associated with a reduction in power with a minimal or some loss of lighting intensity are selected by a user or automatically set by a processor. Greater or lesser percentages may be used. By minimizing reduction of the peak voltage with a lamp having increased lighting output, a reduction in energy consumption with minimal, no or even an increase in light output as compared to a standard lamp is provided.

In one embodiment, the amount of power reduction in the power savings mode is selected as a function of natural light level. A light sensor is provided for detecting the natural light level. With greater amounts of natural light, more power reduction or a greater percentage is used. Ambient light due to sky lights or windows allows for a greater amount of power savings by further reduction in lighting output from increased lumen capable lamps 12. As ambient light decreases, the power savings is reduced for a greater lighting intensity from the lamps 12.

In act 44, the lighting level output decrease due to power reduction at least partially off-sets the lamps having an increased initial lumen rating. Conversely, the lamps having an increased initial lumen rating at least partially off-sets the lighting level output decrease due to power reduction. Since a lighting system in one embodiment is designed for operation with a standard lamp, the off-set allows for similar lighting levels with reduced power consumption. Power conservation may be provided where the lighting output is even greater than a standard ballasted lamp of the same type at full power due to the increased initial lumen output.

In one embodiment, the off-set occurs automatically to avoid destruction of the lamp 12. The energy reduction is set to occur immediately or as quickly as possible to avoid destruction. For example, a HID lamp with increased lumen output may operate at a very high temperature, making destruction of the element more likely. By providing quick energy reduction, the temperature of operation is more quickly reduced or the high temperature avoided.

While the invention has been described above by reference to various embodiments, it will be understood that many changes and modifications can be made without departing from the spirit and scope of the invention. For example, a lighting system 10 is designed to use higher lumen lamps with reduced power. In this example, the standard is based on common usage in other lighting systems at the time.

It is therefore intended that the foregoing detailed description be understood as an illustration of the presently preferred embodiments of the invention, and not as a definition of the invention. It is only the following claims, including all equivalents, that are intended to define the scope of this invention.

What is claimed is:

1. A method for using hi lumen, ballasted lamps, the method comprising:
(a) providing a ballasted lamp with an increased initial lumen output and substantially same wattage rating; and
(b) reducing a power provided to the ballasted lamp during operation.

2. The method of claim 1 wherein (a) comprises providing the ballasted lamp with a decreased life average rated hours.

3. The method of claim 1 wherein (a) comprises increasing a cathode size.

4. The method of claim 1 wherein (a) comprises providing a T8 fluorescent lamp.

5. The method of claim 4 wherein (a) comprises providing the T8 fluorescent lamp with a life average rated hours of less than 15,000, operable at substantially 32 watts, and with at least 4,000 initial lumens.

6. The method of claim 5 wherein (b) comprises reducing a peak voltage to the T8 lamp such that about 3,000 lumens are output.

7. The method of claim 5 wherein (b) comprises reducing an RMS voltage without substantial reduction in peak voltage such that an output of the lamp is reduced from an initial lumens rating but greater than 3,000 lumens.

8. The method of claim 1 wherein (b) comprises dimming the ballasted lamp.

9. The method of claim 1 further comprising:
(c) at least partially off-setting the increased initial lumen output of the ballasted lamp with the reduction of (b);
wherein a lighting level is substantially similar to or greater than a standard ballasted lamp of a same type during operation due to the increased initial lumen output, but power consumption is less due to (b).

10. A system for using hi lumen, ballasted lamps, the system comprising:
a ballasted lamp with an increased initial lumen output and substantially same wattage rating; and
a power reduction device electrically connected with the ballasted lamp.

11. The system of claim 10 wherein the power reduction device comprises a dimmer.

12. The system of claim 10 wherein the power reduction device is operable to provide less RMS voltage with a substantially same peak as a line voltage to the ballasted lamp.

13. The system of claim 10 wherein the ballasted lamp comprises a T8 fluorescent lamp with a life average rated hours of less than 15,000, operable at substantially 32 watts, and with at least a 4,000 initial lumens rating.

14. The system of claim 13 wherein the power reduction device is operable to reduce a power to the T8 fluorescent lamp such that about 3,000 or more lumens are output.

15. The system of claim 10 wherein the power reduction device in conjunction with the ballasted lamp is operable to provide a lighting level substantially similar to or greater than a standard ballasted lamp of a same type as the ballasted lamp due to the increased initial lumen output, but with less power consumption.

16. A method for using hi lumen, ballasted lamps, the method comprising:
(a) reducing energy consumption by, a ballasted lighting system with a energy reduction device separate from lamps of the ballasted lighting system; and
(b) at least partially off-setting a lighting level output decrease due to (a) with at least one lamp of the lamps having an increased initial lumen rating.

17. The method of claim 16 wherein (b) comprises off-setting the lighting level output decrease with the at least one lamp having a substantially same wattage as a standard lamp for use in the ballasted lighting system.

18. The method of claim 17 wherein a standard lamp comprises a fluorescent lamp with about 3,000 or lower initial lumen rating for operating at 32 watts and the at least one lamp has about a 4,000 or more initial lumen rating for operating at 32 watts.

19. The method of claim 17 wherein the ballasted lighting system comprises a plurality of ballasts and T8 fluorescent lamps, the T8 fluorescent lamps operable at substantially 32 watts and having at least a 4,000 initial lumens rating.

20. The method of claim 17 wherein (b) comprises increasing the lighting level output as compared to the standard lamp.

21. The method of claim 17 wherein the standard lamp comprises a lamp designed for use in a lighting system and the at least one lamp's increased initial lumen rating comprises an increase over the design specified lumen rating.
